(19) United States
(12) Patent Application Publication
(10) Pub. No.: US 2019/0015945 A1
(43) Pub. Date: Jan. 17, 2019

(54) BRUSH GRINDING HEAD FOR A GRINDING MACHINE

(71) Applicant: Tyrolit-Schleifmittelwerke Swarovski K.G., Schwaz (AT)

(72) Inventor: Bent ANKERSEN, Herning (DK)

(21) Appl. No.: 16/076,815

(22) PCT Filed: Jan. 26, 2017
(86) PCT No.: PCT/AT2017/060010

§ 371 Date: Aug. 9, 2018

(30) Foreign Application Priority Data
Feb. 26, 2016 (EP) 16157625.1

(51) Int. Cl. B24B 19/22; B24B 23/02; B24B 55/02; B24D 11/02; B24D 13/04; B24D 13/06; B24D 13/10; B24D 13/12

(52) U.S. Cl. CPC B24B 19/22; B24B 23/02; B24B 55/02; B24D 11/02; B29C 33/72; B24D 13/06; B24D 13/10; B24D 13/12; B24D 13/045

(57) ABSTRACT

The invention relates to a brush grinding head (1) for a grinding machine (2), comprising an essentially roller-shaped carrier (3) and grinding lamellae (4), wherein the grinding lamellae (4) are arranged peripherally on the carrier (3) and are composed at least of, in particular bundled brushes (5) and an essentially strip-shaped grinding element (6) which is arranged adjacent thereto. The grinding element (6) comprises at least one abrasive layer (7) and an abrasive-free layer (8) which can be compressed while retaining its shape and is designed in such a way that a grinding fluid (27), in particular water, can be stored in it.

The invention concerns a brush grinding head for a grinding machine, comprising a, particularly drum-formed, carrier and grinding lamellae, wherein the grinding lamellae are arranged on the circumference of the carrier and are composed of at least, particularly bundled, brushes and an adjacently arranged, particularly lamellar, grinding element. The invention further concerns a grinding machine with a brush grinding head according to the invention. And finally the invention concerns special uses of the brush grinding head according to the invention.

Brush grinding heads according to the preamble of claim 1 are already known in the state of the art. In the solution for example described in the CH 687 133 A5 an abrasive paper is being applied as a grinding element. In that case the brush grinding head is used for machining wood, particularly panel boards. Such a brush grinding head though is not suitable for machining a surface of work pieces made of composite materials and also not for being applied in wet grinding. For grinding wood, it is known to moisten the wood with water prior to grinding the wood in order to set upright the fibres of the wood. However, a wet grinding in the sense that a grinding fluid is successively supplied, is undesirable since, for example, a rotting of the wood may occur.

The objective technical problem therefore is to provide a brush grinding head for a grinding machine which solves the disadvantages prescribed according to the state of the art and in particularly can be used for machining the surfaces of composite materials and can be used in wet grinding. A further technical problem is to provide a grinding machine with such a brush grinding head as well as the uses of this brush grinding head.

These problems are solved by the features of the independent claims 1, 11, 13 and 14.

Thus one aspect of the present invention is that the grinding element comprises at least a layer of grinding means and a layer which is free of grinding means, wherein the layer is compressible while maintaining its form and is constructed in such a way, that a grinding fluid, particularly water, is storable in it.

The expression “while maintaining its form” means that the layer free of grinding means is compressible under influence of a load and the layer free of grinding means reaches its original form when the load is not exerted anymore. This characteristic leads to substantially two advantages, namely to that effect that the layer is acting pressure compensatory and is developing a damping effect during the grinding process.

The characteristic, that the layer which is free of grinding means is constructed in such a way, that a grinding fluid, particularly water, is storable in it, has the technical effect that during wet grinding the grinding fluid stored in the layer which is free of grinding means is gradually released and thereby flushing away abrasive dust efficiently.

Opposite to the common machining of surfaces of work pieces made of composite materials by orbit sanders with commercial abrasive paper with the brush grinding head according to the invention it is obtained a considerable reduction of machining time and simultaneous improvement of the surface quality.

As a material for the layer which is free of grinding material for example a soft foamed material is suitable. Soft foamed materials are known to a person skilled in the art. As an example an open-celled polyether polyurethane foam is being mentioned.

According to an embodiment, the grinding element and the brushes of the grinding lamellae are each arranged in a common groove. This has the advantage that a large number of grinding elements and brushes can be arranged on the carrier and that still the required stability of the carrier is ensured. Like this, a good grinding result can be achieved without damaging the carrier. In addition, a simplified production of the carrier is achieved by said measure. If, for example, one grinding element and one brush of the grinding lamellae are arranged in a common groove each, then only half as many grooves are needed compared to the separate arrangement of the grinding elements and brushes, so that a more cost-effective production with less time is possible.

An advantageous further development of the brush grinding head according to the invention is that the layer of grinding means comprises a flexible, in particular textile, carrier layer for the grinding means, which is permeable for the grinding fluid, particularly water. Thereby a particularly advantageous cooperation of the layer which is free of grinding means and the layer of grinding means is obtained, namely in that effect that a grinding fluid stored in the layer which is free of grinding material can pass through the layer of grinding means and abrasive dust, which is established on the layer of grinding means when grinding, can be flushed away efficiently.

In connection with the machining of the surfaces of work pieces made of a composite material it is suitable that the layer of grinding means comprises grinding means which are chosen from a group consisting of diamond and cubic boron nitride, preferably with a grain size of 1 to 270 μm.

It has emerged advantageously that the layer of grinding means comprises a binding agent, preferably a resin-based binding agent. In that case the resin-based binding agent can be chosen form the group consisting of phenolic resin, melamine resin, urea resin, epoxy resin, polyester resin, acrylic resin or polyurethane resin.

In an advantageous manner the brushes are made of natural hair, preferably of cactus hair. The advantage of natural hair to artificial hair is that unwanted electrostatic charges can be avoided and reduced respectively. Such charges would attract particles which could adversely affect the result of grinding the surface.

According to a preferred embodiment the grinding lamellae are each connected to the carrier by an attachment element, wherein the brushes and the grinding element are mounted to the attachment element. In that case the brushes with the grinding elements can be mounted to the attachment element by clamping and/or bonding. The connection of the attachment elements with the carrier can be carried out for example in that the attachment element has in cross-section a geometry of a dove tail and in that in the, particularly drum-formed, carrier corresponding grooves are provided, in which the attachment elements are inserted axially. However, each other form of attachment is possible with which attachment elements can be connected to the carrier, for example bonding, screwing or clamping. Alternatively it is also possible that the grinding lamellae are not connected via an attachment element but are connected directly to the carrier.

In an advantageous manner the brush grinding head comprises a rotational axis and the grinding lamellae are arranged parallel or angular to the rotational axis at the carrier. For that case that the grinding lamellae are arranged angular to the rotational axis of the brush grinding head at the carrier a deflection of the grinding lamellae occurs. In the case of a drum-formed carrier the grinding lamellae are then arranged helically at the carrier.

The result of grinding can be further selectively influenced in that the grinding lamellae are inclined relatively to the surface of the carrier. Inclination relatively to the surface means that the grinding lamellae are not arranged normal to the surface but in an angle deviating from 90°. In that case it is possible that the grinding lamellae are tilted in the direction of the surface to be machined or are tilted in the opposite direction relatively to the normal.

For machining structured surfaces, thus for example surfaces which have an edge or the like, it is suitable that the grinding element is divided into sections. In this manner the brush grinding head can be adapted perfectly to the form of the surface to be machined.

Concerning the grinding machine with a brush grinding head according to the invention advantageous embodiments consist in that the grinding machine comprises hand guide, preferably with a supply for the grinding fluid, and/or a protection shield. In that case the hand guide can be built in such a way that the person for operating the grinding machine is standing on the surface to be machined and is pushing the grinding machine. The protection shield serves to prevent an unwanted spreading of grinding fluid and/or abrasive dust outside of the machining area. In an ideal manner the protection shield is realised transparent in order to allow a visual check for the operator.

It has emerged that the brush grinding head according to the invention can be used particularly well for machining a surface, preferably coated with a clear coat for protection of environmental influences, of a work piece, wherein at least a region of the work piece adjacent to the surface for machining consists of a carbon fibre composite material or a glass fibre composite material. Is the work piece concerning for example a part, preferably a rotor, of a wind energy plant, the mentioned clear coat is protecting wind wheels based offshore from destructive influences of salt-water and salt crystals.

According to the invention also the use of a prescribed brush grinding head for machining a surface, preferably coated with wax, of a cast for the production of a work piece, which at least region-wise consists of a carbon fibre composite material or a glass fibre composite material, is protected. In order to remove the work pieces made in the casts from the casts after the production process a treatment of the surfaces of the casts is necessary. For this a release agent, for example wax, is usually brought onto the casts. Said release agent is also hardening in the production process so that after a certain amount of production cycles the coating has to be worked over or removed. For this purpose the brush grinding head according to the invention can be again used in a perfect manner.

In a particularly advantageous manner the prescribed uses are effected while supplying a grinding fluid, preferably water, particularly preferred water charged with soap.

Further details and advantages of the present invention will be described more fully hereinafter by means of the specific description with reference to the embodiments by way of example illustrated in the drawings, in which:

FIG. 1 shows a brush grinding head in a perspective view,

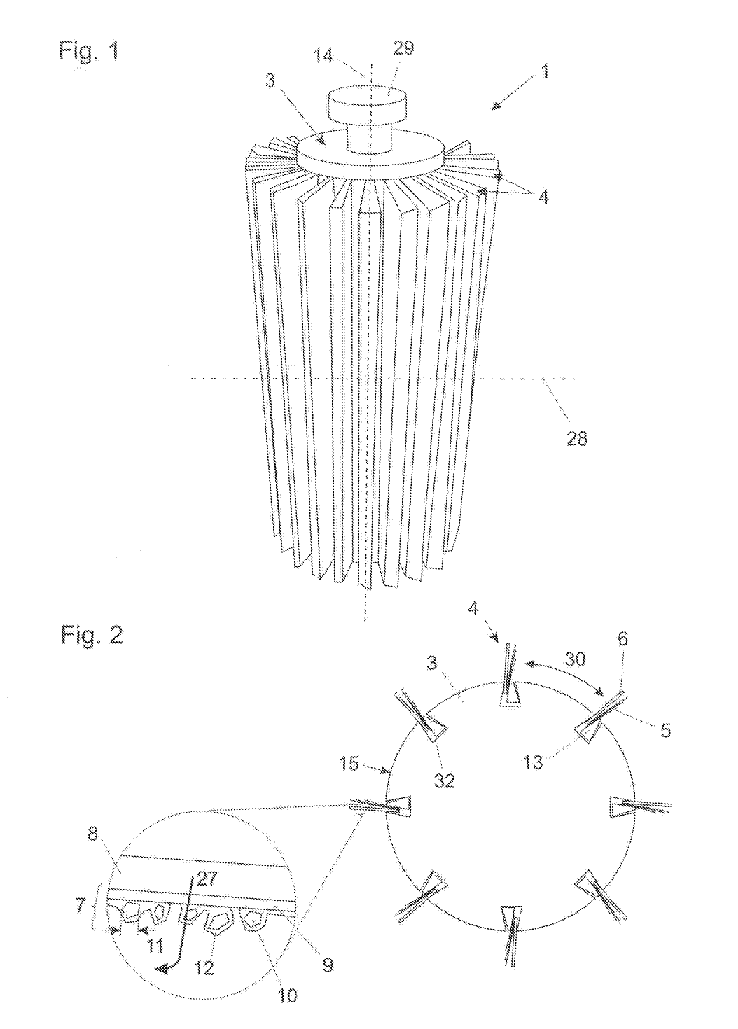

FIG. 2 shows a cross-section of a brush grinding head with an enlarged detail of a grinding element,

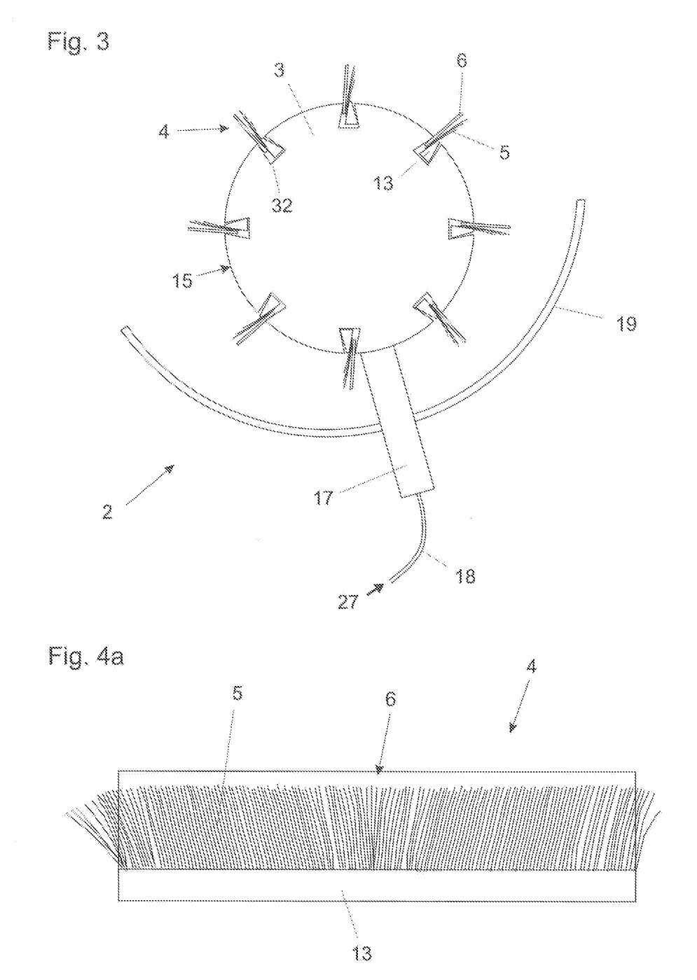

FIG. 3 shows a cross-section of a grinding machine,

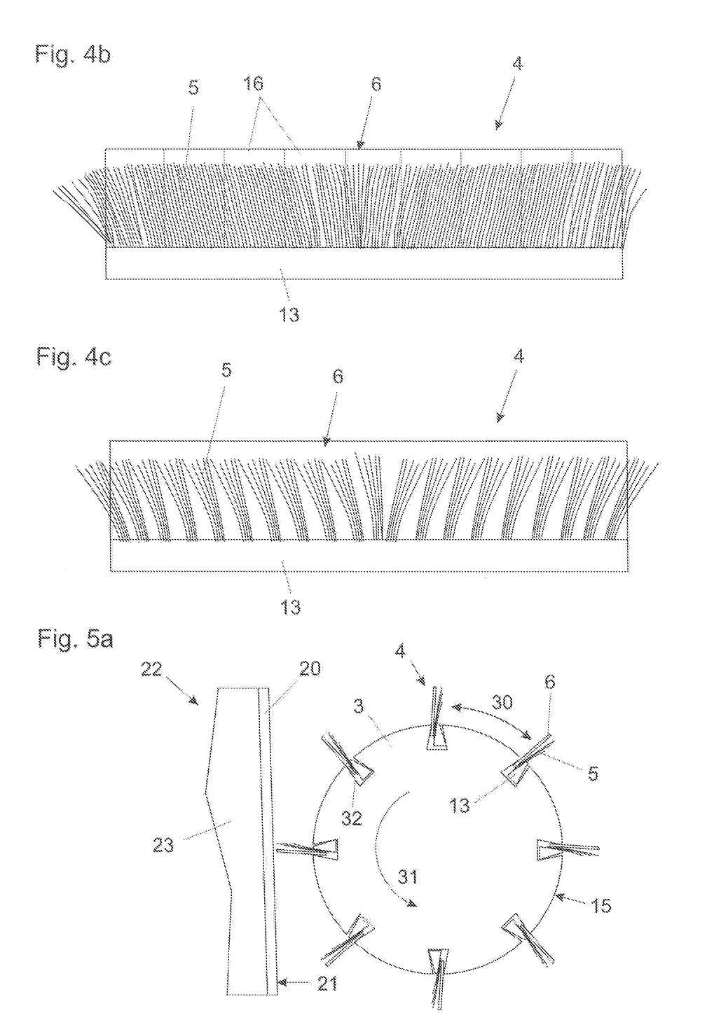

FIGS. 4a-4c show advantageous embodiments of a grinding lamella in a side view,

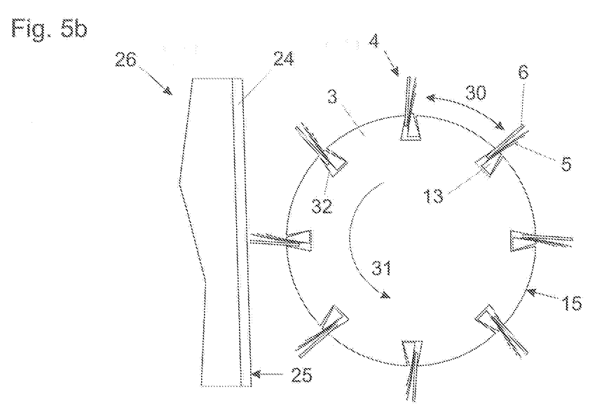

FIG. 5a shows the use of a brush grinding head for machining a surface coated with clear coat of a work piece made of a carbon fibre composite material or a glass fibre composite material and

FIG. 5b shows the use of a brush grinding heat for machining a surface (25) coated with wax of a cast for the production of a work piece made of a carbon fibre composite material or a glass fibre composite material.

FIG. 1 shows a brush grinding head 1 for a grinding machine 2 comprising a drum-formed carrier 3, wherein this carrier 3 is constructed rotationally symmetric in this case.

The brush grinding head 1 further comprises grinding lamellae 4, which are arranged on the circumference of the carrier 3. The brush grinding head 1 comprises a rotational axis 14. The grinding lamellae 4 are arranged parallel to this rotational axis 14 at the carrier 3. Alternatively, an arrangement is possible where the grinding lamellae 14 are aligned angular to the rotational axis 14. In this case, the grinding lamellae 14 would be bent about the radius of the carrier 3 and would be arranged helically at the carrier 3.

The carrier 3 comprises extensions 29 which are arranged at both front faces of the carrier 3 and with which the brush grinding head 1 can be mounted in a grinding machine 2.

Also the drive of the brush grinding head 1 can be effected via the extensions 29. Hereto, it is advantageous to adapt the geometry of the extensions 29 in such a way that in a simple manner a torsional moment can be transferred, for example by arranging at least one groove in which a part of a drive means is engaging form-fittingly.

Finally, the extensions 29 can serve as a further technical function in order to fix the grinding lamellae 4, for example against a shift parallel to the rotational axis 14.

A centering device for centering the brush grinding head 1 in a grinding machine 2 can be arranged in the extensions 29, for example in the form of a central bore.

The extensions 29 can be built in one piece with the carrier 3 or in form of one or several separate structural elements which are connected to the carrier 3, for example via screws.

In FIG. 1 the grinding lamellae 4 are only indicated schematically in their entirety. A more detailed structure originates from FIG. 2, wherein FIG. 2 shows a cross-section view for example along the dotdashed cross-section plane 28 drawn in FIG. 1. In this context it should be indicated that in the cross-section view for reasons of clarity only eight grinding lamellae 4 are considered. The grinding lamellae 4 according to the embodiment of FIG. 2 consist of brushes 5 and an adjacently arranged lamellar grinding element 6, wherein both component, so the brushes 5 and the grinding element 6, are arranged at an attachment element 13 by an adhesive connection. The entirety of brushes 5, the grinding element 6 and the attachment element 13 in form of a slat is then in the area of the attachment element 13 axially inserted in corresponding grooves 32 provided on the circumference of the carrier 3 and are secured against turning by the geometry of the attachment element 13 and the grooves 32 respectively. The grinding lamellae 4 are arranged spaced from one another at the carrier 3. In FIG. 2 the distance of two neighboured grinding lamellae 4 is provided with reference sign 30.

From FIG. 2 it further derives that the grinding lamellae 4 are inclined slightly in comparison to the surface 15 of the carrier 3, this means they are not aligned normal to the surface 15 of the carrier 3 but are slightly tilted compared to this normal. Assuming a grinding direction 31, for example as shown in FIG. 5a, then the shown grinding lamellae 4 are slightly tilted from the normal against the grinding direction 31. Alternatively thereto however a tilting into the grinding direction 31 can be provided if this attains an advantageous grinding result in a specific case of application.

FIG. 2 also comprises an enlarged detail of a grinding element 6. It derives from this view that the grinding element 6 in the shown case consists of a layer 7 of grinding means and a layer 8 which is free of grinding means, wherein this layer 8 which is free of grinding means is compressible while maintaining its form and is constructed in such a way, that a grinding fluid 27, particularly water, is storable in it. Thereby the layer 7 of grinding means comprises a flexible textile carrier layer 9 for the grinding means 10, which is permeable for the grinding fluid 27. So the layer 7 of grinding means contacts the layer 8 which is free of grinding means via the flexible textile carrier layer 9 which is permeable for the grinding fluid 27. The grinding means 10 with a binding agent 12 is arranged at the opposite side of this carrier layer 9. The grinding means 10 is preferably concerning a diamond or cubic boron nitride, preferably with a grain size 11 of 1 to 270 μm. By reference to an arrow it is indicated how the grinding fluid 27 stored in the layer 8 which is free of grinding means can support the grinding process when wet-grinding in such a way that the grinding fluid 27 is supplied to the active side of the layer 7 of grinding means via the carrier layer 9 and there removes abrasive dust.

FIG. 3 shows a cross-section view of an advantageous embodiment of a grinding machine 2 according to the invention, comprising a brush grinding head 1 as shown in FIG. 2, wherein the grinding machine 2 further comprises a hand guide 17 with which die grinding machine 2 can be moved by an operator on the surface to be machined. Yet a supply 18 for the grinding fluid 27 is integrated in the hand guide 17. Further, a part of the brush grinding head 1 is covered by a protection shield 19.

The FIGS. 4a to 4c show three advantageous embodiments of a grind lamella, wherein it concerns in this cases a side view in comparison with the cross-section views of FIGS. 2 and 3. Brushes 5 and lamellar grinding elements 6 are arranged in all three cases at each attachment element 13 in form of a slat, wherein in the case of FIG. 4a the grinding element 6 is formed in one piece and the brushes are not having a special organisation.

In contrast in the case of FIG. 4b the grinding element 6 is separated in several sections 16 which are movable relatively to each other.

In FIG. 4c the brushes 5 are bundled.

Also an alternative combination of the described features of the grinding lamellae 4 is possible, thus for example a bundling of the brushes 5 and a segmentation of the grinding elements 6.

In all three embodiments according to FIGS. 4a to 4c the brushes 5 are formed slightly shorter than the grinding element 6. However, this is not mandatory. Just as well the hairs of the brushes 5 can have the same length as the grinding elements 6 or can even have a greater length.

FIG. 5a shows the use of a brush grinding head 1 for machining a surface 21 of a work piece 22 coated with a clear coat 20 for protection of environmental influences, wherein at least a region 23 of the work piece 22 adjacent to the surface 21 for machining consists of a carbon fibre composite material or a glass fibre composite material. In the shown use the brush grinding head 1 is rotated in such a way that the grinding lamellae 4 are first contacting the surface 21 to be machined with the grinding element 6 and afterwards with the brushes 5.

FIG. 5b shows the use of a brush grinding head 1 for machining a surface 25 coated with wax 24 of a cast 26 for the production of a work piece 22, which at least region-wise consists of a carbon fibre composite material or a glass fibre composite material.

Said work piece 22—which is directly machined in the case of FIG. 5a or which is produced by a cast 26 in the case of FIG. 5b—concerns for example a part, preferably a rotor, of a wind energy plant.

1-13. (canceled)

14. Brush grinding head (1) for a grinding machine (2), comprising a, particularly drum-formed, carrier (3) and grinding lamellae (4), wherein the grinding lamellae (4) are arranged on the circumference of the carrier (3) and are composed of at least, particularly bundled, brushes (5) and an adjacently arranged, particularly lamellar, grinding element (6), characterized in that the grinding element (6) comprises at least a layer (7) of grinding means and a layer (8) which is free of grinding means, wherein the layer (8) is compressible while maintaining its form and is constructed in such a way, that a grinding fluid (27), particularly water, is storable in it.

15. Brush grinding head (1) according to claim 14, wherein the grinding element (6) and the brushes (5) of the grinding lamellae (4) are each arranged in a common groove (32).

16. Brush grinding head (1) according to claim 14, wherein the layer (7) of grinding means comprises a flexible, in particular textile, carrier layer (9) for the grinding means (10), which is permeable for the grinding fluid (27), particularly water.

17. Brush grinding head (1) according to claim 14, wherein the layer (7) of grinding means comprises grinding means (10) which are chosen from a group consisting of diamond and cubic boron nitride, preferably with a grain size (11) of 1 to 270 μm.

18. Brush grinding head (1) according to claim 14, wherein the layer (7) of grinding means comprises a binding agent (12), preferably a resin-based binding agent.

19. Brush grinding head (1) according to claim 14, wherein the layer (7) of grinding means contacts the layer (8) which is free of grinding means via the carrier layer (9) and the grinding means (10) with the binding agent (12) is arranged at the opposite side of the carrier layer (9), such that when wet-grinding the grinding fluid (27) stored in the layer (8) which is free of grinding means can be supplied to an active side of the layer (7) of grinding means via the carrier layer (9) and can there remove abrasive dust.

20. Brush grinding head (1) according to claim 14, wherein the brushes (5) are made of natural hair, preferably of cactus hair.

21. Brush grinding head (1) according to claim 14, wherein the grinding lamellae (4) are each connected to the carrier (3) by an attachment element (13), wherein the brushes (5) and the grinding element (6) are mounted to the attachment element (13).

22. Brush grinding head (1) according to claim 14, wherein the brush grinding head (1) comprises a rotational axis (14) and the grinding lamellae (4) are arranged parallel or angular to the rotational axis (14) at the carrier (3).

23. Brush grinding head (1) according to claim 14, wherein the grinding lamellae (4) are inclined relatively to the surface (15) of the carrier (3).

24. Brush grinding head (1) according to claim 14, wherein the grinding element (6) is divided into sections (16).

25. Grinding machine (2) with a brush grind head (1) according to claim 14.

26. Grinding machine (2) according to claim 25, wherein the grinding machine (2) comprises a hand guide (17), preferably with a supply (18) for the grinding fluid, and/or a protection shield (19).

27. Use of a brush grinding head (1) according to claim 14 for machining a surface (21), preferably coated with a clear coat (20) for protection of environmental influences, of a work piece (22), wherein at least a region (23) of the work piece (22) adjacent to the surface (21) for machining consists of a carbon fibre composite material or a glass fibre composite material.

28. Use of a brush grinding head (1) according to claim 14 for machining a surface (25), preferably coated with wax (24), of a cast (26) for the production of a work piece (22), which at least region-wise consists of a carbon fibre composite material or a glass fibre composite material.

29. Use according to claim 27, wherein the use is effected while supplying a grinding fluid (27), preferably water, particularly preferred water charged with soap.

30. Use according to claim 27, wherein the work piece (22) is a part, preferably a rotor, of a wind energy plant.

31. Brush grinding head (1) according to claim 15, wherein the layer (7) of grinding means comprises a flexible, in particular textile, carrier layer (9) for the grinding means (10), which is permeable for the grinding fluid (27), particularly water.

32. Brush grinding head (1) according to claim 15, wherein the layer (7) of grinding means comprises grinding means (10) which are chosen from a group consisting of diamond and cubic boron nitride, preferably with a grain size (11) of 1 to 270 μm.

33. Brush grinding head (1) according to claim 16, wherein the layer (7) of grinding means comprises grinding means (10) which are chosen from a group consisting of diamond and cubic boron nitride, preferably with a grain size (11) of 1 to 270 μm.
